(19) United States
(12) Patent Application Publication
(10) Pub. No.: US 2013/0040028 A1
(43) Pub. Date: Feb. 14, 2013

(54) CIRCULATORY MILK FROTHING DEVICE

(71) Applicants: Matthias Doppe, Langenau (DE); Martin Neumayer, Gerstetten-Dettingen (DE)

(72) Inventors: Matthias Doppe, Langenau (DE); Martin Neumayer, Gerstetten-Dettingen (DE)

(73) Assignee: WMF WURTTEMBERGISCHE METALLWARENFABRIK AKTIENGESELLSCHAFT, Geislingen/Steige (DE)

(21) Appl. No.: 13/522,092

(22) PCT Filed: Jan. 14, 2011
(86) PCT No.: PCT/DE2011/000035

§ 371 Date: Oct. 19, 2012

(30) Foreign Application Priority Data
Jan. 14, 2010 (DE) 10 2010 004 730.9

(51) Int. Cl. A47J 31/04; A23C 9/00; A01J 11/04

(52) U.S. Cl. 426/474; 99/452; 99/294

(57) ABSTRACT

The present invention relates to a milk-frothing unit comprising a frothing chamber, a suction portion which leads into the frothing chamber and an outflow which leads out of the frothing chamber, the frothing chamber, the suction portion and the outflow being configured such that milk can be suctioned in via the suction portion and guided into the frothing chamber and can be frothed up therein with gas and/or steam, in particular air and/or water vapour, which is supplied to this frothing chamber and in that the milk-froth mixture resulting from the frothing can be discharged out of the frothing chamber via the outflow, characterised in that the frothing chamber, the suction portion and the outflow are configured and disposed such that the milk to be suctioned in and the discharged milk-froth mixture can be guided in a circulation.

The present invention relates to a milk-frothing unit for frothing up milk by means of supplied gas and/or steam (air and/or water vapour) according to the preamble of claim 1. Furthermore, the invention relates to a riser pipe machine (in particular to an espresso maker) and a fully automatic coffee machine, comprising such a milk-frothing unit, and also to a corresponding method for frothing up milk. The milk-frothing unit according to the invention can be configured in particular also as an adaptor for connection to a commercially available riser pipe machine or as an adaptor for connection to a steam nozzle of an electric coffee machine (in particular a so-called semi-automatic machine).

Various devices for producing milk froth are known already from the state of the art. One class of devices functions solely by means of mechanical movement or by introducing mechanical energy into the milk (immersion of a mechanically moved frothing head into the milk). In the case of semi-automatic devices, it is also known to introduce steam which is produced in the device into hot milk which is situated in an external vessel; the steam then rises from the bottom upwards in the milk, as a result of which simultaneous heating and frothing of the milk is effected (introduction of heat energy into the milk). Finally, milk-frothing units which also produce in addition (by pushing a button) milk froth, according to the selected drink, are known. The frothing is hereby effected in a so-called frother in which the suctioned-in milk is suctioned in from a first separate vessel (e.g. Tetra-Pak containing milk) frothed in the device and then dispensed to a second external vessel (cup or glass).

The milk frothers or milk-frothing units known from the state of the art have however at least one of the following disadvantages:
the quality of the milk froth can only be reproduced with difficulty,
the production of the milk froth demands high time expenditure,
the production of the milk froth without contamination is possible only with difficulty
(in particular this applies for the introduction of steam into the milk poured into an external vessel; in the case of handling which is not optimal, spraying of milk and/or of milk froth out of this vessel is often effected here) and/or
the degree of frothing of the milk (i.e. that proportion of milk which is converted into milk froth) can only be reproduced with difficulty and/or adjusted only within a comparatively narrow range.

It is therefore the object of the present invention to make available a milk-frothing unit with which, in a simple, reliable and reproducible manner, qualitatively high-grade milk froth can be produced and the degree of frothing of the milk can be varied reproducibly within a wide range. Furthermore, the object is to make available riser pipe machines and/or fully automatic coffee machines which are provided with a corresponding milk-frothing unit and also a corresponding frothing method.

The object is achieved by a milk-frothing unit according to the invention according to claim 1, by a riser pipe machine according to the invention according to claim 12, by a fully automatic coffee machine according to the invention according to claim 15, and also by a frothing method according to the invention according to claim 16. Advantageous embodiment variants can be deduced respectively from the dependent claims. In particular, a milk-frothing unit according to the invention can also be configured as an adaptor for connection to a steam nozzle of a semi-automatic machine or for connection to a commercially available riser pipe machine (externally heated espresso machine).

Subsequently, the present invention is firstly described in general, then with reference to several embodiments. The features shown in the individual embodiments, given by way of example, of the present invention need not thereby be produced together exactly in the combinations shown in the embodiments, but can be produced together also in other combinations, within the scope of the protective rights prescribed by the patent claims. In particular, some of the features shown in the embodiments given by way of example can also be omitted or combined otherwise with further shown features.

Unless otherwise stated, there are understood, within the scope of the present invention, by riser pipe machines or devices according to the riser pipe principle, externally or internally heatable devices which have a liquid container into which a riser pipe portion or a riser pipe opens. The inflow is thereby effected such that heated liquid and/or liquid steam (after production of high pressure in the liquid container) is pushed upwards out of the liquid container through the riser pipe portion and can be discharged or reused. The construction and operating principle of such a riser pipe machine are basically known thereby to the person skilled in the art.

Unless otherwise stated subsequently, the riser pipe machines configured according to the invention and/or the riser pipe machines which can be used according to the invention together with milk-frothing units according to the invention which are configured for example as adaptors are configured such that the lower end of the riser pipe portion or riser pipe ends in the upper region of the liquid container, i.e. above the liquid level when the liquid container is filled up. Accordingly, no rising of liquid through the riser pipe is effected after forming a high pressure (by heating the liquid in the liquid container), rather only liquid steam which has formed above the liquid level is pushed through the riser pipe. According to the invention, unless otherwise stated, merely liquid steam (water vapour) is hence pressed through the riser pipe and used according to the invention (as is described subsequently in more detail). In the simplest case, this can be achieved by maintaining a sufficient spacing of the lower end of the riser pipe from the inner base of the liquid container.

Furthermore, a riser pipe machine according to the present invention (as becomes more clear in the subsequently described embodiments) need not comprise all the individual parts which are present in a commercially available riser pipe machine (in particular: espresso machine): in particular, the upper container (into which the heated coffee which has risen through the riser pipe is introduced in the case of commercially available riser pipe machines) can be dispensed with. Likewise, the lower and the upper throughflow filter and also the receiving container for the coffee powder can be dispensed with. However, this does not preclude a riser pipe machine according to the invention being configured (e.g. by providing a plurality of exchangeable inserts) such that it can be used both for producing coffee and for frothing milk.

The basic idea of the present invention is to suction in the milk, to froth up the suctioned-in milk by means of supplied gas and/or steam (air and/or water vapour) and to discharge the mixture of milk and milk froth resulting from the frothing (subsequently also abbreviated and termed milk-froth mixture or even more briefly as milk froth) such that the milk to be suctioned in and the discharged milk-froth mixture are guided or can be guided in a circulation. In particular, such a circulation or cycle of milk and/or milk froth (the milk-frothing unit according to the invention hence operates according to a circulation method) can be effected within the scope of a single-chamber system, i.e. using one and the same vessel for holding the milk to be suctioned in and the milk froth to be dispensed.

The suctioning-in of the milk can be effected advantageously according to the invention according to the Venturi principle, basically however it is also conceivable to use one or more conveying pump(s) for suctioning-in, frothing-up and discharging the milk and/or the milk froth. The circulation or cycle comprising suctioning-in, frothing-up and discharging can thereby be continued until a percentage of milk froth desired by the operator (up to a degree of frothing of 100%, i.e. all the milk present is converted into milk froth) is achieved: the mixture of milk and milk froth can hence be conducted several times and as frequently through the milk-frothing unit according to the invention until a desired degree of frothing is achieved.

In other words, providing a circulation or cycle method according to the invention means that the milk which is not yet converted into milk froth can be suctioned in, frothed up and discharged several times. If precisely one vessel is thereby used (single-chamber system), then this means that the storage chamber (for milk) and the discharge or outflow chamber (for milk froth) are identical.

As described subsequently in more detail, external heating sources can be used within the scope of the invention so that the invention can be produced for example in riser pipe machines without using any electrical and/or electromechanical components. As an alternative thereto, the riser pipe machines can however also be provided with electrical heating sources for heating the liquid in the liquid container.

According to the invention, in particular integration of an electronic control unit is also possible, which ends the frothing process when the milk is completely frothed up, when a predetermined degree of frothing is achieved and/or when (as a function of a quantity of milk which has been introduced) a predetermined process duration is achieved. For this purpose, either purely a time control (ending of the frothing after a predefined timespan, e.g. after 5 to 10 seconds) can be effected: for example, an optical sensor can be disposed inside the suction portion with the help of which the beginning of the suctioning-in process can be detected by detecting when the optical sensor is covered by the throughflowing milk (which is judged to be the beginning of the above-described timespan). Or a predetermined degree of frothing can be detected via different methods: for example, it is possible, by means of the above-described sensor or a light barrier in the suction portion, to undertake a differentiation between liquid and an air-froth mixture or between various proportions of liquid in the suctioned-in mixture by an optical route. The level in the vessel can also be determined (for example likewise by an optical route, e.g. with a light barrier), the level in the vessel increasing with an increasing degree of frothing. Likewise, audio measurements are conceivable (assessment of the suction noise which changes with an increasing degree of frothing). The above-described control methods can also be used in combination, as an alternative thereto or also in conjunction with the above-described control methods, image-processing methods can likewise be used (optical detection and assessment of the milk-frothing measurement in the vessel and/or in the suction portion, for example with the help of CCD sensors or CMOS sensors).

According to the invention, it is also possible to provide the milk-frothing unit with a temperature sensor. This can be disposed for example in the inlet, in the cross-section tapering region or in the outlet of the Venturi nozzle of a milk-frothing unit according to the invention such that, with it, the temperature of the milk or of the milk-froth mixture can be detected and, on the basis of the detected temperature, the supply of gas and/or steam into the frothing chamber of the Venturi nozzle can be controlled.

A milk-frothing unit according to the invention comprises a frothing chamber, a suction portion which leads into this frothing chamber and an outflow which leads out of the frothing chamber. The frothing chamber, the suction portion and the outflow are configured such that milk can be suctioned in via the suction portion and guided into the frothing chamber. The milk is then frothed up in the frothing chamber with gas and/or steam (in particular in the form of air and/or water vapour). The milk-froth mixture resulting from the frothing-up is discharged out of the frothing chamber via the outflow. Frothing chamber, suction portion and outflow are thereby configured, shaped and disposed such that the milk to be suctioned into the frothing chamber (or provided that the circulation has already been run through once, the mixture of milk and milk froth to be suctioned in) and the milk-froth mixture discharged from the frothing chamber are guided in a circulation.

Preferably, the configuration and arrangement of the previously mentioned components of the milk-frothing unit is effected such that one and the same vessel is used for suctioning in milk or the mixture of milk and milk froth and for discharging the mixture resulting from the frothing-up. Frothing chamber, suction portion and outflow are therefore configured and disposed such that one and the same quantity of milk and/or milk froth can be conducted several times through these three units.

The length of the outflow can be designed thereby advantageously such that the end of the outflow which is orientated away from the frothing chamber 1 (outlet opening of the outflow) can be positioned below the liquid level of the milk, i.e. for example near the base of the vessel. Such an extension of the outflow up to below the milk surface in the vessel has the advantage that spraying and formation of coarse bubbles can be avoided.

Advantageously, the milk is suctioned into the frothing chamber via the suction portion with the help of a differential pressure, is frothed up there and discharged again via the outflow or supplied again to the circulation. For this purpose, in particular, a further inflow leading into the frothing chamber (subsequently: inflow portion) can be provided, with which the gas and/or the steam can be conducted into the frothing chamber, then frothing chamber, suction portion, outflow and inflow portion being configured preferably in the form of a Venturi nozzle. The frothing chamber can thereby configure the cross-section tapering region of this Venturi nozzle and/or of the throughflow element consisting of inflow portion and outflow, then the suction portion opens into this cross-section tapering region (the Venturi nozzle principle is known basically to the person skilled in the art: by means of the tapering of the Venturi nozzle, the gas and/or steam flowing in through the inflow portion entrains the milk via the suction portion placed in the cross-section tapering region, as a result frothing of the milk is effected in the region of the cross-section tapering or of the frothing chamber before the thus produced mixture is dispensed via the outflow).

As an alternative thereto, it is however also possible to provide at least one conveying pump for suctioning in the milk via the suction portion, for conveying the same into the frothing chamber and for discharging the milk-froth mixture via the outflow. The conveying pump(s) effects/effect thereby advantageously also the supply of the gas and/or of the steam into the frothing chamber.

In a further embodiment according to the invention which is produced preferably within the scope of a semi-automatic machine provided with a steam nozzle or a fully automatic coffee machine provided with a steam- and air supply, the inflow portion, the suction portion and the outflow are connected to each other via a tube branch. If the Venturi principle is produced according to the invention, then the tube branch can configure the Venturi nozzle, a part of the same, the cross-section tapering region of the Venturi nozzle or a part of the same.

In a further advantageous embodiment based on the Venturi nozzle principle, the suction region or the Venturi nozzle and/or the cross-section tapering region of the same (for example based on an extendable piston which changes the line cross-section in the suction region or in the cross-section tapering region) can be changed with respect to the cross-section.

In a further advantageous variant, the milk-frothing unit can be configured as an adaptor which is suitable for connection to a commercially available riser pipe machine (for preparing a hot drink, in particular coffee). The individual components of the milk-frothing unit are then adapted to the riser pipe machine such that the liquid steam (produced after forming the high pressure in the liquid container) is pushed through the riser pipe portion of the riser pipe machine and can be introduced into the frothing chamber of the milk-frothing unit. The steam driven by the high pressure can hence be used for frothing up the milk in the frothing chamber.

Likewise, it is possible to configure the milk-frothing unit as an adaptor for connection to the steam nozzle of an electric coffee machine (semi-automatic machine): the individual components of the milk-frothing unit are thereby produced for example such that the inflow portion of the milk-frothing unit is clamped securely to the steam nozzle. The steam flowing out of the steam nozzle can then be introduced into the frothing chamber of the milk-frothing unit and used for frothing up the milk.

A riser pipe machine according to the invention which comprises a milk-frothing unit according to the invention can concern in particular, a riser pipe machine which is configured without any electrical and electromechanical components. Said riser pipe machine comprises a liquid container in which liquid (water) can be heated by means of a heating source. The heating source is preferably an external heating source (for example an electric or gas hob on which the riser pipe machine is placed), however as an alternative thereto, an internal heating source incorporated in the riser pipe machine (e.g. a heating coil according to the electric kettle principle) can be provided for heating the liquid. The riser pipe machine has furthermore a riser pipe portion which is configured and disposed such that liquid steam (water vapour) produced by heating the liquid in the liquid container is driven upwards through the riser pipe portion by a high pressure formed in the liquid container by the heating. For this purpose, the lower end of the riser pipe portion opening into the liquid container can be positioned in the liquid container such that, even with a virtually completely filled liquid container, it is still situated above the liquid level in the liquid container. The lower end is disposed in this case such that rising of liquid, caused by high pressure, through the riser pipe portion is prevented, i.e. such that rising of steam through the riser pipe portion alone is made possible.

The riser pipe portion or the upper end thereof is then configured and disposed such that, with it, the rising liquid steam is pushed into the frothing chamber of the milk-frothing unit integrated in the riser pipe machine and hence frothing of the milk is possible. The riser pipe portion or the upper end thereof can be configured, for this purpose, as at least one part of the above-described inflow portion of the milk-frothing unit.

Preferably, the riser pipe machine according to the invention is configured such that the liquid steam can rise upwards through the riser pipe portion only from a predetermined minimum high pressure in the liquid container (preferably in the range of 0.2 to 4 bar, particularly preferred in the range of 0.5 to 1.5 bar). As described subsequently in more detail, this can be produced for example with the help of a lifting element.

In a further advantageous embodiment variant, the riser pipe machine has an upper container which can be connected to the liquid container (preferably can be connected and/or screwed on in a pressure-tight manner), which container is configured as that vessel out of which the milk can be suctioned and into which the milk-froth mixture resulting from frothing this milk can be discharged.

Likewise, it is conceivable to integrate the milk-frothing unit according to the invention in a fully automatic coffee machine, such that, inside the fully automatic coffee machine, the milk to be suctioned in and the discharged milk-froth mixture can be guided in a circulation. For this purpose, a suitable milk-receiving container which allows a corresponding circulation guidance can be configured inside the fully automatic coffee machine.

The invention is described subsequently with reference to embodiments. There are shown for this purpose:

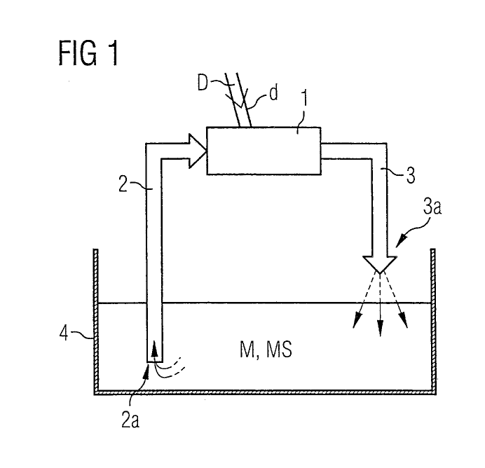

FIG. 1 a basic circulation principle according to the present invention.

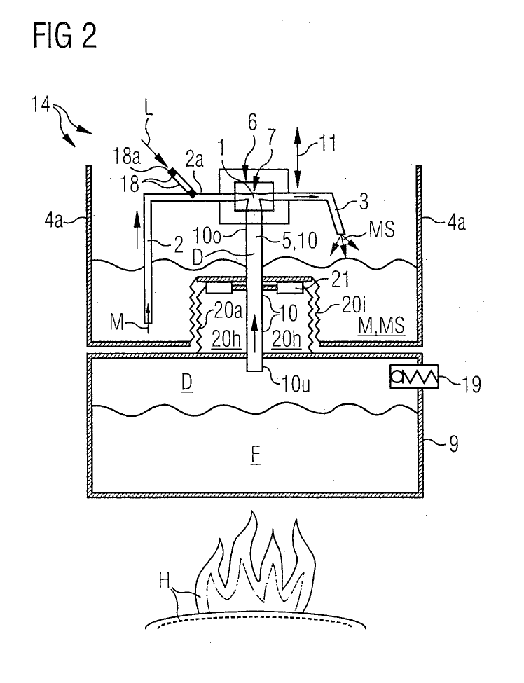

FIG. 2 a riser pipe machine according to the invention which integrates a milk-frothing unit according to the invention.

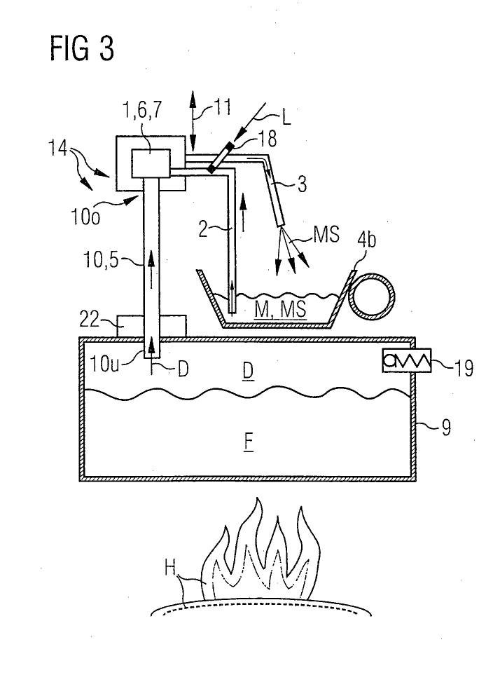

FIG. 3 a further riser pipe machine according to the invention which integrates a milk-frothing unit according to the invention.

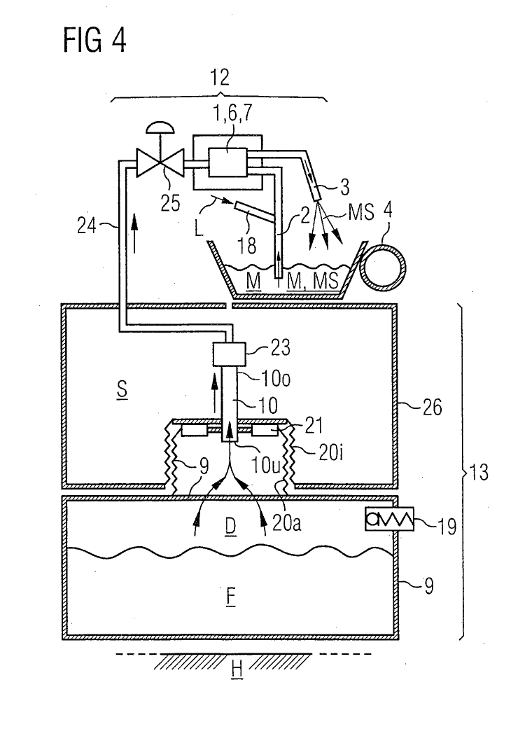

FIG. 4 a milk-frothing unit according to the invention which is configured as an adaptor for connection to a riser pipe machine.

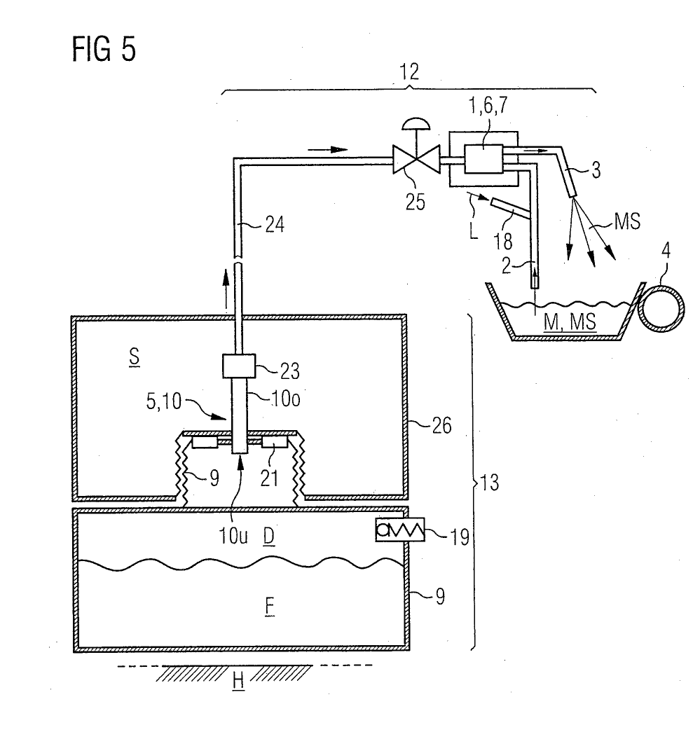

FIG. 5 a further milk-frothing unit according to the invention which is configured as an adaptor for connection to a riser pipe machine.

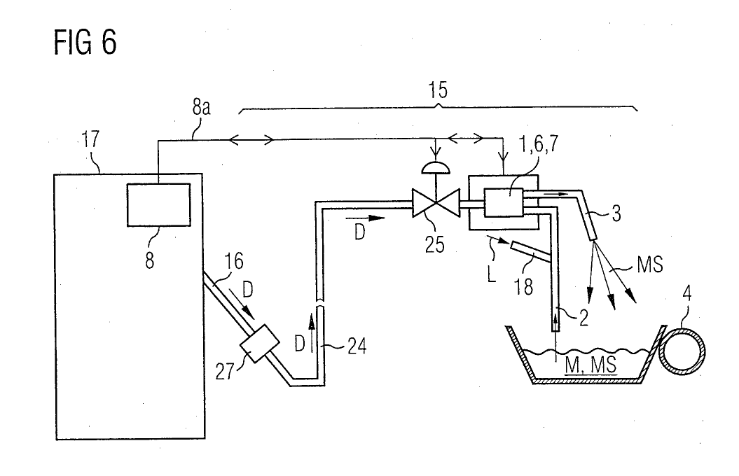

FIG. 6 a milk-frothing unit according to the invention which is configured as an adaptor for connection to a steam nozzle of an electric coffee machine.

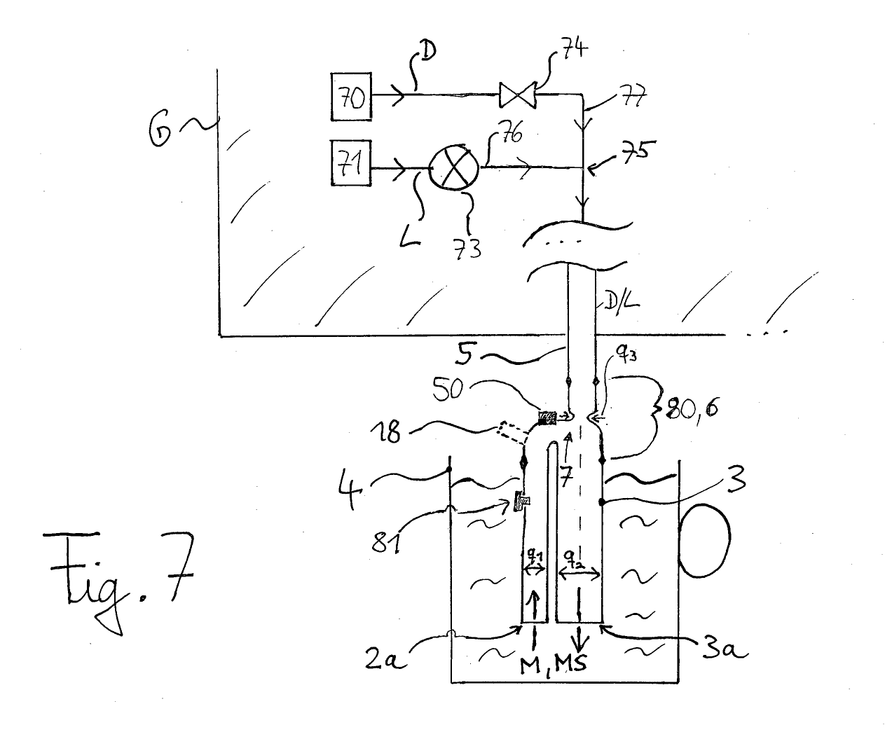

FIG. 7 a fully automatic coffee machine provided with a steam- and air supply, to which a milk-frothing unit according to the invention is connected flexibly in portions.

FIG. 1 sketches a milk-frothing unit according to the invention which has a frothing chamber 1, a suction portion 2 which leads into this frothing chamber and an outflow 3 which leads out of the frothing chamber. Via a separate pressure line d, water vapour D can be supplied under high pressure to the interior of the frothing chamber 1. The elements 1, 2, 3, d are configured here as Venturi nozzle, the pressure line d forming the inlet of the Venturi nozzle, the outflow 3 the outlet of the Venturi nozzle and the suction portion 2 the removal pipe or the suction pipe of the Venturi nozzle. The frothing chamber 1 corresponds to a cross-section tapering of the line guide from the pressure line d towards the outflow 3, the suction portion 2 at this tapering point of the cross-section leading into this line guide, i.e. into the frothing chamber. An air-suction portion 18 which leads, in the flow direction, in front of the frothing chamber 1 into the circulation (which opens generally by its one end into the suction portion 2 and the other end thereof is disposed above the maximum level to be expected in the vessel 4 in order to suction in air L, see subsequently) can likewise be present here advantageously but is not shown here.

If steam D under pressure is pushed through the pressure line d into the frothing chamber 1, then the Venturi nozzle suctions milk M out of the vessel 4 by means of the suction portion 2 according to the Venturi principle known to the person skilled in the art, froths up this milk inside the frothing chamber 1 by means of the supplied steam D and discharges the resulting milk-froth mixture MS via the outflow 3. Vessel 4, suction portion 2 and outflow 3 are thereby configured and positioned such that both the suctioning-in of the milk M and the discharge of the milk-froth mixture MS out of this vessel 4 or into it is effected. For this purpose, the suctioning-in end 2a of the suction portion 2, which is orientated away from the frothing chamber, viewed with respect to a predetermined liquid level in the vessel 4, is disposed below this liquid level and the end 3a of the outflow 3 which dispenses the milk-froth mixture MS and is orientated away from the frothing chamber is disposed above this liquid level. Viewed vertically, these two ends 2a, 3a are hence disposed at a spacing from each other here, the suctioning-in end 2a of the suction portion 2 being disposed in the region of the inner base of the vessel 4, but at a spacing from the latter. Alternatively thereto, it is however also conceivable to dispose the two ends 2a, 3a at one and the same level below the predetermined liquid level (which corresponds to a minimum level of milk in the vessel 4) and in the region of the inner base of the vessel 4. In a further embodiment (e.g. via a purely manually adjustable level- or height control or else via an electrical control), the vertical position of the end 2a inside the vessel 4, i.e. the spacing between the base of the vessel 4 and the end 2a, can be adjusted variably. This height control of the suction has for example the advantage that the degree of frothing can be adjusted variably: if the end 2a is disposed just below the liquid level M in the vessel 4, then the degree of frothing is less than in the arrangement of the end 2a close to the base.

The principle described with respect to FIG. 1, unless otherwise stated, is integrated in the described form as milk-frothing unit in the subsequent further embodiments.

Thus FIG. 2 shows a riser pipe machine 14 according to the invention which integrates such a milk-frothing unit and manages without any electrical and electromechanical components.

The riser pipe machine 14 comprises firstly, like a commercially available riser pipe machine according to the state of the art, a liquid container 9 which is provided at its upper end with an internally hollow outer thread 20a, water F being able to be filled into the liquid container 9 via the cavity 20h thereof. This liquid container 9 is made of a heat-resistant material and can therefore be placed on an external heating source H (e.g. electric hob) and heated via the latter. Entirely analogously to a commercially available riser pipe machine, the riser pipe machine 14 according to the invention has furthermore an upper container 4a which is provided with an inner thread 20i which corresponds to the above-described outer thread 20a and can be screwed with the latter in a pressure-tight manner onto the outer thread of the (lower) liquid container 9. The annularly extending gasket 21 which is disposed on the upper end of the outer thread 20a ensures the pressure-tightness of the connection of the upper container 4a (after being screwed thereon) to the lower liquid container 9 so that pressure can be built up in the interior of the container 9. Finally, a safety valve 19 is configured in a wall of the liquid container 9, which safety valve opens automatically inside the vessel 9 from a predefined pressure of 4 bar here and hence prevents a safety risk due to too high a pressure in the container 9.

In contrast to a commercially available riser pipe machine, no insert into which coffee is poured is however provided in the machine 14, said coffee then being subjected to a flow by rising liquid as a result of high pressure. Instead, the lower end 10u of the riser pipe portion 10 (subsequently termed also riser pipe 10 for simplification) ends in the upper region of the liquid container 9 and inside the same directly below the lower end of the outer thread 20a. The spacing of the lower end 10u of the riser pipe 10 from the inside of the base of the liquid container 9 to be placed on the heating source H is hence so large that, even with almost complete filling of the liquid container 9 with water F, the water level is below this end 10u.

Just as with a commercially available riser pipe machine, the lower end 10u of the riser pipe 10 is disposed in the liquid container 9 and the upper end 10o of the riser pipe 10 inside the upper container 4a. The riser pipe 10 hence leads from the upper region of the interior of the container 9 inside the thread 20a, 20i and through the base of the upper container 4a into the interior thereof.

In contrast to a commercially available riser pipe machine, the upper region of the riser pipe 10 and the upper end 10o thereof are now configured as inflow portion 5 of a milk-frothing unit according to the invention: hence the milk-frothing unit is disposed here as an attachment on the upper end of the riser pipe 10.

The frothing chamber 1, the suction portion 2, the outflow 3 and the upper part of the riser pipe 10 which is configured as an inflow portion 5 form a Venturi nozzle 6 as follows: a first end of the suction portion 2 is disposed in the region of the interior of the upper container 4a which is close to the base. This end opens via a pipe portion 2a of the suction portion 2 above the upper end 10o of the riser pipe 10 and above a predetermined filler content in the container 4a (which corresponds to a maximum milk- or milk-froth filler content in the container 4a) into the Venturi nozzle attachment 6 of the milk-frothing unit according to the invention. This end of the suction portion 2 opens inside the Venturi nozzle 6 into the frothing chamber 1 which is configured as a cavity in the form of a cross-section tapering 7 of the Venturi nozzle. At the end of the frothing chamber 1 which is situated opposite the inlet of the suction portion 2, viewed horizontally, the inner cross-section of the Venturi nozzle widens conically according to the Venturi nozzle principle and consequently forms the end of the outflow 3 which is orientated towards the frothing chamber 1. This end opens into a horizontal pipe portion of the outflow 3 against which a short downwardly bent portion abuts, via which portion, see subsequently, the outflow of the milk-froth mixture MS out of the outflow 3 into the upper container or vessel 4a is effected. Opposite the suctioning-in end of the suction portion 2 which is disposed in the base region, i.e. below the filler content in the upper vessel 4a, the outflowing end of the outflow 3 is disposed above this filler content, i.e. viewed vertically, at a spacing from the suctioning-in end of the suction portion 2.

The inflow portion 5 or the upper part of the riser pipe 10 opens from below into the above-described narrow-point region 7, i.e. into the interior of the frothing chamber 1. According to the Venturi nozzle principle, the inflow portion 5 tapers conically when opening into the frothing chamber.

The mode of operation of the illustrated riser pipe machine 14 is as follows: firstly, water F is poured into the liquid container 9 via the internally hollow outer thread 20a of the liquid container 9, i.e. through the hollow volume 20h, such that the water level is situated below the position of the lower end 10u of the riser pipe 10. Subsequently, the upper container 4a (with the riser pipe 5, 10 fixed thereon and also the milk-frothing unit 1, 2, 3, 6, 7 fixed detachably on the riser pipe) is screwed together with the lower liquid container 9 in a pressure-tight manner. Then filling of the upper container 4a with milk M is effected. Subsequently, heating of the water F on the hob H is effected. As a result, a steam pressure atmosphere D forms above the liquid level in the container 9. After a predetermined high pressure is reached inside the liquid container 9 (see subsequently), water vapour D is pushed upwards inside the riser pipe 10, according to the riser pipe principle, i.e. through the inflow portion 5 of the milk-frothing unit.

The consequently produced flow of water vapour D through the inflow portion 5 and the outflow 3 now entrains liquid, i.e. milk M, according to the Venturi principle, via the suction portion 2 on the basis of a static low pressure caused by the cross-section tapering. The milk M which is suctioned in or entrained through the suction portion 2 is hence frothed up inside the frothing chamber 1 or at the narrow point 7 of the Venturi nozzle 6 by the rising water vapour D and is discharged as milk-froth mixture MS via the outflow 3 of the Venturi nozzle into the upper vessel 4a.

Since both the suction portion 2 and the outflow 3 open into the upper container 4, the outflowing milk froth MS is mixed with the milk M to be suctioned in. Hence the above-described circulation is produced, in which one and the same quantity of milk or milk froth can be suctioned in and frothed up several times by renewed suction via the suction portion 2, mixing with rising water vapour D and discharge via the outflow 3.

The illustrated riser pipe machine 14 hence represents an externally heated milk frother with a milk-frothing unit according to the cycle principle in the single-chamber system: the external heating H heats the water content F such that the steam volume D is formed with sufficient energy supply. In order to produce sufficient high pressure in the container 9, not only should a pressure-tight connection 21 be formed between the two containers 9 and 4a but also firstly the milk-frothing unit 1, 2, 3, 5, 6 and 7 should be locked in a pressure-tight manner: this takes place here by the milk-frothing unit being configured as a mechanical lifting element 11. The lifting element 11 has, for this purpose, a (not illustrated) catch which can be locked manually firstly by pushing the milk-frothing unit downwards and is released only at a predefined minimum high pressure inside the liquid container 9 (here e.g. 1.0 bar) (as a result of which the lifting element 11 or the milk-frothing unit is pushed upwards, as a result of the pressure, and consequently it becomes possible for the water vapour D to flow through the inflow portion 5, the frothing chamber 1 and the outflow 3 and hence for milk to be suctioned in via the suction portion 2. Hence if the pressure exceeds the pretensioning force of the lifting element 11 or of the milk-frothing unit, then the steam D rises through the riser pipe 10, 5 upwards into the frothing chamber 1 and suctions the milk M situated in the upper container 4a through the suction portion 2 according to the above-described Venturi principle.

In order to ensure the desired and/or an optimum frothing of the milk M, an air suction portion 18 in the region of the horizontal pipe portion 2a of the suction portion 2 leads into the suction portion 2. The end 18a which is situated remotely from this horizontal pipe portion 2a (air-suction end) of the air-suction portion 18 is disposed above this horizontal pipe portion 2a so that, even at the maximum filler content in the container 4a, it is possible to suction in air L. Via this air-suction portion 18, in addition to the milk M, also air L can be suctioned into the suction portion 2. The air-suction portion can be configured to be closable so that, after closure by means of the Venturi effect, only milk (froth) M, MS is still suctioned in via the portion 2, 18, but no longer air L. This offers the possibility of rapid heating of the milk but the pay-off is possibly a certain “diluting effect” by mixing with condensed steam.

The dispensing of the frothed milk M is hence effected in turn into the upper container 4a. At the beginning of the suction process of the milk M, the mixture situated in the upper container 4a hence consists for example of up to 100 percent milk. As a result of constant resuctioning 2, frothing 1 and outflowing 3 of milk M or milk froth MS, the percentage of liquid milk M in the upper container 4a constantly reduces. At the same time, the proportion of milk froth MS increases so that, at the end of the process which can be ended independently, for example by a user, the content of the upper container 4a consists of milk froth MS up to at most 100 percent.

As an alternative thereto, it is also possible to design the device 14 such that conversion of liquid milk into milk froth by means of the above-described circulation is ended automatically after a predetermined time duration. For this purpose, for example a timer with selectable duration of the process can be integrated in the device 14 and is started by releasing the above-described catch of the lifting element 11. Finally, it is likewise possible to configure the device 14 such that the above-described circulation is ended automatically after reaching a predefined degree of frothing.

In order to be able to produce the minimum high pressure (admission pressure) which is required for the frothing process within the liquid container 9, the container 9 must be able to be sealed in a pressure-tight manner. This takes place as described above by screwing the two elements 4a, 9 one into the other by means of the gaskets 21. As an alternative thereto, it is however also possible to provide connection techniques, such as e.g. a bayonet socket, a snap-in closure (on one side with a hinge or on both sides for complete removal of the upper part 4a) or also other connection techniques. Only when the starting pressure required for the frothing process (here e.g. 1 bar) is achieved, is the steam passage D through the riser pipe 10, 5 and the outflow 3 hence opened by a pressure-caused lifting of the lifting element 11 or of the milk-frothing unit.

The above-described lifting element 11 which is used for the admission pressure generation can thereby be achieved in different ways: lifting elements which can be operated purely manually and are locked and released for example manually, are just as conceivable as semi-automatic or fully automatic lifting elements. In the case of semi-automatic lifting elements 11, for example manual actuation of the catch (sealing) can be effected, the subsequent releasing of the catch can be effected automatically, for example after a predefined time (purely time-dependent opening), in the case of a predefined pressure (via a predefined spring pretension or a snap-in element etc.) or temperature-caused (for example using a bimetal snap disc or a bimetal).

The steam passage is hereby intended to be opened, after reaching the minimum high pressure, as promptly as possible, i.e. without noteworthy time delay (principle of an admission pressure-controlled 2/2 way valve). Implementation of this function is effected here by forming the milk-frothing unit as a lifting element such that this lifting element 11 has a locked position in a lower end position in which the riser pipe 10, 5 is sealed relative to the interior of the Venturi nozzle 6 or to the frothing chamber 1. After exceeding the minimum high pressure, the lifting element 11 is pushed into an upper end position as a result of the pressure, the catch is hence released so that steam D passes into the Venturi nozzle 6 and the frothing process is started. For this purpose, in addition a switch which starts the suction process via the suction portion 2 after pushing the lifting element 11 upwards can also be provided.

Subsequently, further embodiments of milk-frothing units according to the invention and/or riser pipe machines according to the invention which comprise such units are described. These are constructed basically as described in FIGS. 1 and 2 so that only the differences are subsequently described.

FIG. 3 shows a further riser pipe machine 14 according to the invention, the milk-frothing unit 1, 2, 3, 6, 7 of which is configured here likewise in the form of a lifting element 11 which is placed on the upper end 10o of the riser pipe portion 5, 10 and fixed detachably there.

In contrast to the case shown in FIG. 2, the riser pipe machine 14 comprises however no upper container 4a which can be screwed onto the liquid container 9. Instead, a filling connection pipe 22 in the form of a hollow boring provided with an inner thread is configured on the upper side of the liquid container 9. The lower end 10u of the riser pipe portion 10 has a corresponding outer thread, with the help of which this lower end 10u, after filling the container 9 via the hollow boring of the filling connection pipe 22 with water F, can be screwed into the filling connection pipe 22. The above-described catch is configured here on the upper end 10o of the riser pipe portion 10 (not shown) so that, here also, after securely screwing the lower end 10u inside the filling connection pipe 22, firstly pressure-tightness in the liquid container 9 is produced. After exceeding the above-described minimum high pressure, lifting of the milk-frothing unit or of the lifting element 11 is effected in the upper region 10o of the riser pipe portion 10 so that throughflow of the liquid steam D through the supply portion 5 or the riser pipe 10, the frothing chamber 1 and the outflow 3 and hence suctioning-in of the milk M via the suction portion 2 can be effected. The milk M is suctioned here out of an external vessel (cup 4b) which is placed on the upper side of the liquid container 9 on the latter. The lower ends of the suction portion 2 and of the outflow 3 are disposed and configured such that the above-described circulation for multiple suction and dispensing of milk M or milk froth MS from/on the vessel 4b can be produced.

FIG. 3 hence shows a modification of the principle described with respect to FIG. 2 by modifying the vessel 4: the upper container 4a configured in FIG. 2 is replaced here by a separate vessel 4b (glass, cup, container for intermediate transport or the like). A connection thread 20 together with sealing element 21 is hence unnecessary here. Instead, the filling connection pipe 22 which is combined here with the riser pipe 10, 5 is provided for the filling. The connection to the liquid container 9 is effected here via a threaded connection piece. As an alternative thereto, the filling connection pipe 22 can also be disposed separately on the liquid container 9 or on the pressure body, i.e. separated from the riser pipe 10, 5.

This variant has the advantage that a refill process is dispensed with, i.e. that the frothed milk-froth mixture MS can be introduced directly into the container 4b provided for consumption. In addition, the number of components for producing the circulation function according to the invention is reduced, hence the piece costs are reduced. Finally, in this combination the riser pipe with the milk-frothing unit can be cleaned very easily manually or in a dishwasher.

FIG. 4 shows the configuration of a milk-frothing unit according to the invention as an adaptor 12 for connection to a commercially available riser pipe machine for preparing coffee. This commercially available riser pipe machine 13 comprises a lower part or a liquid container 9 and also an upper part 26 (collection container) which can be screwed onto this lower part 9 in a pressure-tight manner 21. When using the adaptor 12 (see subsequently) in conjunction with the commercially available riser pipe machine 13, the coffee powder insert of the riser pipe machine is simply omitted.

The adaptor 12 according to the invention has a tube portion 24, at the one end of which a clamping element 23 is configured. With the help of the clamping element 23, the adaptor 12 or the one tube end 24 thereof can be clamped securely at the upper exit 10o of the upper riser pipe portion 10 (which leads into the upper part 26 and with which normally the hot coffee is conducted into the collection chamber of this upper part 26). After clamping securely, the riser pipe portion 10 and the tube portion 24 form a pressure-tight connection, through which, after heating the liquid F in the container 9 by means of the heat source H, liquid steam D is pressed.

At the end situated opposite the clamping element 23, the tube portion 24 has a valve 25 which can be opened manually. As an alternative thereto, a valve 25 which opens automatically upon reaching a predetermined minimum high pressure of e.g. 1 bar can be provided.

The tube portion 24 here forms the inflow portion of the milk-frothing unit with which the water vapour D can be introduced into the frothing chamber 1 of the Venturi nozzle 6 or into the cross-section tapering 7 of the Venturi nozzle 6.

If hence the valve 25 is opened manually, then liquid steam D flows via the riser pipe 1, the clamping element 23 and the tube portion 24 and also the valve 25 into the frothing chamber 1 and entrains milk M from the separate vessel 4 (via the suction portion 2) according to the Venturi principle. The milk is frothed up in the frothing chamber 1, as described above, and the resulting milk-froth mixture MS is dispensed into the same vessel 4 via the outflow 3.

The adaptor 12 according to the invention (which comprises the elements 1, 2, 3, 6, 7, 23, 24 and 25) is configured for example by providing a suitable tube length 24 and a suitable housing unit (not shown here) integrating the elements 1, 2, 3, 6, 7 and 25 and can be disposed such that the milk/milk-froth circulation can be produced inside an external container 4 placed on the upper side of the upper part 26.

FIG. 4 hence shows a milk-frothing unit according to the invention in the form of an adaptor 12 for a commercially available riser pipe machine or a commercially available expresso maker. The adaptor 12 is hereby connected in a pressure-tight manner to the basic device or espresso maker 26 by means of the clamping unit 23. The insert for coffee powder (the—lower—riser pipe portion of which protrudes into the water reservoir F) is not thereby mounted. Upon heating H and hence the following pressure build-up, a steam pressure D is hence present at the valve 25. If this valve is opened manually, the steam flows through the milk-frothing unit and froths the milk M situated in the cup 4 correspondingly to make MS.

This embodiment has the advantage in particular of being able to produce milk froth also by means of an already existing espresso maker with an added device (adaptor).

FIG. 5 shows a modification of the principle shown in FIG. 4, in which the adaptor 12 is configured as a mobile adaptor for placing on separate containers 4 which are placed for example next to commercially available riser pipe machines 13.

For this purpose, the tube portion 24 is extended so far that the milk-frothing unit 1, 2, 3, 6, 7, 25 can be placed directly on the container 4 (e.g. drinking cup). On the basis of extending the tube portion 24, a plurality of drinking vessels 4 can be laid out adjacently and prepared with milk at the same time (assuming a sufficient tube length of e.g. 50 cm). If the housing unit (not shown) of the milk-frothing unit is suitably configured, i.e. it enables rapid placing of the milk-frothing unit in succession on the individual external containers without the result being spraying of milk or milk froth out of the respectively used container (this can be produced for example by a planar configuration of the lower housing end, the shape of which is adapted to the upper edge of the containers 4), then simultaneous frothing in a plurality of external vessels 4 is in practice possible.

Starting and stopping of the frothing process can be effected respectively by a switch which is produced in the above-described housing and is to be operated manually. As an alternative thereto, it is also possible to provide a push-button switch which is opened automatically by placing the housing on a container 4 and is closed again by lifting the housing up from this container.

FIG. 6 shows finally a further embodiment in which the milk-frothing unit is likewise configured as an adaptor, as shown in FIGS. 4 and 5 (so that only the differences from FIGS. 4 and 5 are subsequently described), this adaptor 15 being configured however with its tube portion 24 via a connection element 27 for connection to the steam nozzle 16 of an electric coffee machine 17 (semi-automatic machine). With a suitable tube length 24 of e.g. 60 cm, just as described with reference to FIG. 5, a quasi-simultaneous operation of a plurality of external containers 4 (glasses or cups) is possible.

In addition, the coffee machine 16 here can have an electronic control unit 8 which is connected via a control line 8a to the valve 25 and to an optical sensor (not shown) which is disposed on the housing of the milk-frothing unit (not shown). With the help of the sensor, the filler content of milk M inside an external vessel 4 can be determined by an optical route and the electronic control unit 8 can be informed. The connection 8a is hence bi-directional.

From the informed level in the respective vessel 4, the electronic control unit 8 automatically calculates a time duration for the frothing of the milk in the respective vessel 4. The time duration can thereby be controlled such that it rises linearly with the respectively present quantity of milk in the vessel 4. However, also a different control behaviour can be provided. For example, with the help of a correlation stored in a memory of the electronic control unit 8 in the form of a look-up table, the time duration can be controlled such that a predetermined degree of frothing is achieved as a function of the quantity of milk M present in the container 4.

In FIG. 6, a commercially available espresso maker is hence no longer used as steam source D, but rather an electric coffee machine in the form of a semi-automatic filter machine, as is known from gastronomy. Such machines have a steam nozzle 16 for frothing up milk, with the help of which steam can be discharged out of the machine and milk being able to be frothed up in a separate vessel by introducing this steam. The milk-frothing unit according to the invention is then connected to this steam nozzle 16 with the help of the connection element 27.

By using the milk-frothing unit according to the invention, preparation of milk froth can hence be simplified and rationalised even in the case of the above-described semi-automatic machines and also a quantity of froth which is precisely portioned can be achieved.

FIG. 7 shows a part of the automatic coffee machine according to the invention, the milk-frothing unit of which is configured on the basis of the already described Venturi nozzle principle. The components of this device corresponding to the previous embodiments are characterised with the same reference numbers so that merely the differences are described subsequently.

In the housing G of the illustrated fully automatic machine, a compressed air source which comprises a motor 71 and an air pump 73 operated by the latter is configured for conducting air L in a line 76 for air supply. The pump 73 (which acts also as valve) opens via a simple T-shaped line part 75 into a steam supply line 77. Upstream of this inlet, firstly a steam producer 70 (boiler) for producing hot steam D is provided in the steam supply line 77 (viewed in the flow direction). Downstream of the boiler 70, a controllable shut-off valve (valve 74) is provided in the line 77 before the line 76 opens into the line 77. The line portion downstream of the inlet of the air supply line 76 into the steam inflow 77 is configured as inflow portion 5, i.e. here as inlet of the Venturi nozzle 6. Via this inflow portion, steam or a mixture D/L of steam and air at high pressure is supplied to the Venturi nozzle 6. The mixture ratio of steam and air in the mixture D/L can be adjusted via control of the valve 74 and also of the conveying power of the pump 73. For this purpose, the last-mentioned elements are connected to an electronic control unit not shown here (corresponding to the electronic control unit 8 shown in FIG. 6) which actuates these elements.

Immediately downstream of the frothing chamber 1 (which is configured here as cross-section tapering region 7 of the Venturi nozzle 6), a temperature sensor 50 is disposed in the suction portion 2 (in the end thereof orientated towards the chamber 1), i.e. in the suction pipe of the Venturi nozzle 6. Said temperature sensor is configured here as thermoresister and is connected likewise to the electronic control unit (not shown) via a data line, not shown.

The pipe of the inflow portion 5 and the pipe of the outflow 3 are flush here, i.e. are disposed along one and the same straight line (broken line in FIG. 7) so that the mixture D/L can flow into the outflow 3 without slowing down.

The temperature of the milk M or of the milk-froth mixture MS can be detected by the temperature sensor 50 immediately upstream of the frothing chamber 1.

On the basis of the measured temperature, the flow characteristic of the Venturi nozzle can be controlled by varying the quantity and/or the supply rate (supplied quantity per unit of time) of steam D and/or air L in the inflow portion 5 by means of suitable adjustment of the elements 73 and 74. In particular, as a function of the detected 50 temperature measuring value, the mixture ratio D/L of steam and of air in the supply to the Venturi nozzle can also be varied.

For example, the supply of steam and hence the entire preparation of the milk/milk froth, upon reaching a target temperature (which is preferably in the range between 60 and 70° C.), can be ended by means of the valve 74. Also the supply of the quantity of air or the duration of the air supply can be effected as a function of the temperature in order to obtain the desired frothing result. Not only the absolute temperature but also the rate of the temperature rise can thereby be used as control parameter since, when the supplied quantity of steam is known, this makes it possible to draw conclusions about the quantity of the milk reserve.

In the illustrated embodiment, the air supply line 76 (with the elements 71 and 73) can also be omitted: in this case (illustrated here in broken lines), an air suction portion 18 (e.g. a simple air hole here) can be provided at the end of the suction portion 2 (similarly as described for FIG. 2), via which air suction portion air from the environment is entrained towards the frothing chamber 1 by means of steam D flowing in via the inflow portion 5 according to the Venturi principle.

The temperature sensor 50 can be disposed alternatively also at the upper or at the lower end 3a of the outflow 3 inside the same.

The ends of the suction portion 2, of the outflow 3 and of the inflow portion 5, which are connected to each other (i.e. orientated towards the frothing chamber 1), are configured here as a tube branch 80. The tube branch 80 hence forms the Venturi nozzle 6 and the cross-section tapering region 7 of the same. The tube branch 80 is thereby configured as a rigid element; the portions of the suction portion 2 and of the outflow 3 which are connected to this tube branch 80 (which portions can then be immersed in the vessel 4) have a flexible configuration. As an alternative thereto, the tube branch 80 can also have a flexible configuration, the portions of the elements 2, 3 and 5 connected to said tube branch 80 can then have a rigid configuration.

For the ratio of the inner cross-sections q₃ and q₂ of the tapering 7 and of the outflow 3, there applies here q₃/q₂=1/1.5.

Furthermore, as FIG. 7 shows, the Venturi nozzle 6 of the automatic coffee machine according to the invention has a variable cross-section: for this purpose, a boring is provided in the suction pipe 2 in the wall thereof, in which boring an extendable mechanical piston 81 is disposed. This piston 81 is connected to the electronic control unit via a control line (not shown). With the electronic control unit, extension and again retraction of the piston end orientated towards the interior of the suction pipe 2 can hence be achieved via the control line. By extending this end of the piston 81, the free inner cross-section of the suction pipe 2 is reduced in the region of the narrow point 7 of the Venturi nozzle, by withdrawing this piston end, this inner diameter is increased again. By retracting the piston end into the interior of the suction pipe 2, the suctioned-in quantity of milk M or milk froth MS can hence be reduced.

If the suction pipe 2 is made narrower, less milk per unit of time is suctioned in and consequently relatively more air is admixed. This leads to larger bubbles so that the composition of the milk froth changes. Due to the reduced dynamics, the result is less mixing in the vessel.

If, in contrast thereto (by extending the piston 81), the inner cross-section q₃ of the tapering 7 is “reduced” relative to the cross-section in the suction pipe 2, the result is less steam/air per unit of time (in comparison with the suctioned-in milk). In this case, the suction low pressure is reduced and the heating lasts for longer. As a result, the air is possibly emulsified better in the milk.

As an alternative thereto, it is of course also possible to configure the piston 81 in the region of the narrow point 7 such that the narrow point itself has a variable cross-section. A further alternative is to change the cross-section ratio or one of the cross-sections by variable squeezing of a flexible tube (of the elements 2, 3 and/or 5).

By means of the above-described embodiments, the following advantages of the milk-frothing units according to the invention become plain:

Simple and reliable constructive principle for rapid heating and frothing of milk in many design- and function variants.

Adaptor solutions for espresso makers, semi-automatic machines or fully automatic coffee machines, which are already present, are possible just as newly designed riser pipe machines which integrate milk-frothing units according to the invention.

By suitable shaping of the individual elements, liquids can be prevented readily from overflowing.

In comparison with the state of the art, higher temperatures of the milk-/milk-froth mixture M, MS can be achieved, a higher separation definition in the case of milk/coffee mixed drinks and hence improved optics can be achieved because of the reproducibility of the milk-frothing.

On the basis of the variants shown in FIGS. 7 and 8, a very flexible pivoting mechanism for the suction portion 2 and the outlet 3 of the Venturi nozzle can be achieved: on the one hand, the elements 2 and 3 can have a flexible configuration, e.g. as flexible silicone tubes. The inflow portion 5 and the tube branch 80 can thereby be disposed securely in a housing of a fully automatic coffee machine or semi-automatic machine. However, this can also be achieved via a flexibly designed tube branch, as a result of which suction pipe and outlet of the Venturi nozzle can be moved easily so that a virtually freely pivotable bearing is configured between the elements 2, 3 and 5. Complex mechanical bearings of the suction- and of the outlet portions of the milk-frothing unit (e.g. based on ball and socket joints) can hence be avoided. By removing the tube branch, the milk-frothing unit described in FIG. 7 can in addition be cleaned simply, rapidly and thoroughly.

1. Milk-frothing unit comprising
a frothing chamber, a suction portion which leads into the frothing chamber and an outflow which leads out of the frothing chamber,
the frothing chamber, the suction portion and the outflow being configured such that milk can be suctioned in via the suction portion and guided into the frothing chamber and can be frothed up therein with gas and/or steam, in particular air and/or water vapour, which is supplied to this frothing chamber and that the milk-froth mixture resulting from the frothing-up can be discharged out of the frothing chamber via the outflow,
wherein the frothing chamber, the suction portion and the outflow are configured and disposed such that the milk to be suctioned in and the discharged milk-froth mixture can be guided in a circulation.

2. The milk-frothing unit according to claim 1,
wherein the frothing chamber, the suction portion and the outflow are configured and disposed such that milk can be suctioned in from a vessel by means of the suction portion and in that the milk-froth mixture resulting from this milk by frothing can be discharged by means of the outflow into precisely this vessel
and/or
in that the frothing chamber, the suction portion and the outflow are configured and disposed such that one and the same quantity of milk and/or milk-froth can be conducted several times through these units.

3. The milk-frothing unit according to claim 1,
wherein the frothing chamber, the suction portion and/or the outflow is/are configured and disposed such that milk can be suctioned into the frothing chamber via the suction portion by means of a differential pressure, can be frothed up there and can be discharged via the outflow
and/or
in that, integrated in and/or connected to the frothing chamber, the suction portion and/or the outflow, a conveying pump is configured for suctioning in the milk via the suction portion, for conveying the milk into the frothing chamber and for discharging the milk-froth mixture via the outflow, the conveying pump preferably being configured also for supplying the gas and/or steam into the frothing chamber.

4. The milk-frothing unit according to claim 1,
wherein the length of the outflow is chosen such that its end orientated away from the frothing chamber, i.e. its inlet opening, can be positioned or is positioned below the liquid level of the milk in an external vessel.

5. The milk-frothing unit according to claim 1,
wherein an inflow portion which leads into the frothing chamber for supplying the gas and/or steam into the frothing chamber, at least portions of the frothing chamber, of the suction portion, of the outflow and of the inflow portion being configured as Venturi nozzle, the frothing chamber being configured in the and/or as cross-section tapering region of this Venturi nozzle, and the inflow portion and/or the suction portion opening into this cross-section tapering region.

6. The milk-frothing unit according to claim 5,
wherein the inflow portion, the suction portion and the outflow can be connected or are connected to each other via a tube branch or in that ends of these elements which are connected to each other are configured as tube branch, the tube branch preferably configuring or comprising the Venturi nozzle or a part of the same.

7. The milk-frothing unit according to claim 5,
wherein a Venturi nozzle which can be varied (81) with respect to its line cross-section in the cross-section tapering region and/or in the inflow portion (50), in the suction portion and/or in the outflow.

8. The milk-frothing unit according to claim 1,
wherein a temperature sensor (50) which, preferably by arrangement in the interior of the frothing chamber, of the suction portion or of the outflow, is disposed and configured for detecting the temperature of the milk to be suctioned in and/or of the discharged milk-froth mixture, and
an electronic control unit which is connected to the temperature sensor and with which the quantity and/or the supply rate of the gas and/or steam supplied to the frothing chamber can be adjusted as a function of the detected temperature or of a determined temperature rise.

9. The milk-frothing unit according to claim 2,
wherein an electronic control unit which is configured such that the time duration of the frothing of milk can be controlled as a function of a predetermined quantity of milk provided for frothing, in particular a quantity of milk which can be poured and/or is poured into the vessel,
and/or
an electronic control unit which is configured such that the frothing of milk is ended if a predetermined, preferably variably adjustable, degree of frothing of a predetermined quantity of milk provided for the frothing, in particular of a quantity of milk which can be poured and/or is poured into a vessel is achieved, wherein the degree of frothing corresponds to the mass ratio of the already frothed milk to the predetermined quantity of milk provided for the frothing.

10. The milk-frothing unit according to claim 1,
wherein the milk-frothing unit is configured such as an adaptor for connection to a riser pipe machine, in particular to a riser pipe machine for preparing coffee and/or tea, and/or comprises an adaptor configured in this way such that liquid steam D, in particular water vapour, can be pushed out of the liquid container of the riser pipe machine as a result of high pressure, through the riser pipe portion of the riser pipe machine and can be supplied to the frothing chamber of the milk-frothing unit in order to froth up the milk.

11. The milk-frothing unit according to claim 1,
wherein the milk-frothing unit is configured such as an adaptor for connection to a steam nozzle of an electric coffee machine and/or comprises an adaptor configured in this way such that steam discharged from the steam nozzle can be supplied to the frothing chamber of the milk-frothing unit in order to froth up the milk.

12. A riser pipe machine, in particular riser pipe machine configured without any electrical and electromechanical components, comprising
a liquid container in which liquid, in particular water, can be heated by means of an external or an integrated heat source, and
a riser pipe portion which opens such by its lower end into the liquid container and which is configured and disposed such that liquid steam produced by heating the liquid in the liquid container, in particular water vapour, as a result of high pressure can be pushed upwards through the lower end of the riser pipe portion and in the latter,
wherein a milk-frothing unit, the riser pipe portion and/or its upper end is configured and disposed such that, with it/them, the liquid steam can be pushed into the frothing chamber of the milk-frothing unit in order to froth up the milk,
the milk-frothing unit being is configured such that the riser pipe portion and/or its upper end forms/form at least a part of the inflow portion of the milk-frothing unit.

13. The riser pipe machine according to claim 12,
wherein the liquid steam can be pushed upwards only from a predetermined minimum high pressure in the liquid container, in particular only from a minimum high pressure in the range of 0.2 to 4 bar, through the lower end of the riser pipe portion and in the latter,
the milk-frothing unit or a part of the same and/or the riser pipe portion or a part of the same comprising preferably for this purpose a lifting element and/or being configured as such a lifting element.

14. The riser pipe machine according to claim 12,
wherein the milk-frothing unit is configured, the vessel being a container which can preferably be connected and/or screwed in a pressure-tight manner, to the liquid container, and/or which can be disposed above the liquid container.

15. Automatic coffee machine with integrated milk-frothing unit, the milk-frothing unit being configured according to claim 1.

16. Method for frothing up milk with a milk-frothing unit according to claim 1,
wherein the milk is a) suctioned in via the suction portion, b) guided into the frothing chamber and c) frothed therein with gas and/or steam, in particular air and/or water vapour, which is supplied to the frothing chamber, and the milk-froth mixture resulting from the frothing is discharged out of the frothing chamber via the outflow,
wherein the milk to be suctioned in and the discharged milk-froth mixture are guided in a circulation through the suction portion, the frothing chamber and the outflow.
